(19) United States
(12) Patent Application Publication
(10) Pub. No.: US 2006/0144765 A1
(43) Pub. Date: Jul. 6, 2006

(54) Conductivity measurement and monitoring system for a fluid treatment system

(76) Inventor: Timothy Skwiot, winona, MN (US)

Correspondence Address: CUNO INCORPORATED, 400 RESEARCH PARKWAY, P. O. BOX 1018, MERIDEN, CT, 06450-1018, US

(21) Appl. No.: 11/027,760

(22) Filed: Dec. 30, 2004

(51) Int. Cl. B01D 35/143

(52) U.S. Cl. 210/85; 210/93; 210/96.1; 96/417

(57) ABSTRACT

A reverse osmosis water filtration system for use with a water supply dispenser. The system can include an output assembly, a manifold, and a control unit. The output assembly can include at least one status indicator and a power supply and can be adapted to be mounted on the water supply dispenser. The manifold can include a manifold housing defining various input and output channels and flow paths, a filtration media, and various sensor elements. The manifold can be mounted remote from the outlet assembly. For example, the manifold can be mounted under a sink or counter while the outlet assembly is mounted on a faucet in one embodiment of a residential water filtration system. The control unit can include a microprocessor having an internal ratiometric comparator such that the system can determine an effectiveness of the filtration media based upon a relative conductivity between inlet and product water flows.

### BACKGROUND OF THE DISCLOSURE

The present disclosure relates generally to the field of water filtration systems. More specifically, the disclosure relates to a conductivity measurement and monitoring system for a fluid delivery and/or treatment system, for example, a reverse osmosis water filtration system, such as those used in consumer residences.

Commercial and consumer fluid delivery systems, such as water filtration systems designed for use in the home, are well known. As a particular example, due to increasing concerns with regard to water quality and associated health concerns, whether supplied by a well or a municipality, the popularity of consumer filtration systems has increased markedly. Water filtration systems designed for use in the home, such as, for example, refrigerator-based systems, under-sink systems, and whole-house systems, can be used to remove contaminants from water supplies. For example, the inclusion of water filtration systems in refrigerators, once considered a luxury feature, is now included as a standard feature in many models, excluding entry level refrigerator designs.

Some water filtration systems incorporate reverse osmosis filtration. Generally, reverse osmosis systems comprise a reverse osmosis membrane assembly, a control element, a purified water outflow, and a tubing/piping assembly defining the various flow paths. Some reverse osmosis systems further comprise a pressure tank that allows for a more rapid, instantaneous delivery rate. In general, an inlet water source is supplied to the membrane assembly where it is separated into a purified water stream (commonly referred to as permeate) and a concentrated waste stream (commonly referred to as concentrate). The permeate may flow to the pressure tank where it can subsequently be accessed through the pure water faucet. The concentrate can be piped directly to drain. The control element working in conjunction with a series of valves in the tubing/piping assembly and the pure water faucet generally can monitor operation of the system and may comprise various monitoring sensors, for example conductivity/resistivity and flow sensors to evaluate whether the system is functioning properly.

### SUMMARY OF THE DISCLOSURE

A reverse osmosis filtration system, for example a residential reverse osmosis water filtration system as described herein can comprise a manifold, first and second sensor elements, an outlet assembly, and a control unit. The manifold can comprise a housing, an inlet channel, and a product channel. A filtration media is placed in the flow between the inlet channel and the product channel and can be a reverse osmosis membrane. The first and second sensor elements can be respectively positioned within the inlet and outlet channels, with the first sensor element placed within the flow on an inlet side of the filtration media and the second sensor element placed within the flow on a product side. The outlet assembly can comprise at least one status indicator and a power source. The control unit can be mounted in the manifold and electrically coupled to the outlet assembly and in presently preferred representative embodiments comprises a microcontroller that includes a ratiometric comparator in electrical communication with the first and second sensor elements at a microcontroller port. A signal at the port is related to a relative conductivity between the first and second sensor elements.

In one aspect, a control unit for a reverse osmosis filtration system according to presently preferred representative embodiments described herein has a microcontroller comprising a ratiometric comparator and at least one output port. The control unit can also comprise a first sensor element interface and a second sensor element interface arranged in series, with a node between the first and second sensor elements electrically connected to the ratiometric comparator. An output interface of the control unit can be electrically connected to the at least one output port of the microcontroller. The control unit can also comprise an interface for a remote power source.

In another aspect, a method of monitoring a reverse osmosis filtration system according to one presently preferred representative embodiment of the invention comprises the steps of detecting a fluid flow; exciting a first sensor element arranged in an inlet fluid flow by an alternating current; exciting a second sensor element arranged in a product fluid flow by an alternating current; and measuring a voltage across the first sensor element and the second sensor element. The method can further comprise the steps of determining a relative conductivity of the inlet and product fluid flows from the voltage; determining whether or not a total dissolve solids (TDS) reduction percentage satisfies acceptable performance criteria; and outputting a system status indicator based upon the TDS reduction percentage.

The above summary of the various aspects of the present disclosure is not intended to describe in detail each illustrated embodiment or the details or every implementation of the present disclosure. The figures in the detailed description that follow more particularly exemplify these presently preferred representative embodiments. These, as well as other objects and advantages of the present disclosure, will be more completely understood and appreciated by referring to the following more detailed description of the described presently preferred representative embodiments of the present disclosure in conjunction with the accompanying drawings.

### BRIEF DESCRIPTION OF THE DRAWINGS

FIG. 1 is a flow schematic of a presently preferred representative embodiment of a reverse osmosis filtration system.

FIG. 2 is a circuit schematic of a presently preferred representative embodiment of a reverse osmosis water filtration conductivity measurement and monitoring system.

FIG. 3 is a schematic view of a presently preferred representative embodiment of a printed circuit board of a reverse osmosis water filtration conductivity measurement and monitoring system.

FIG. 4 is a flowchart of a control program of a microcontroller of a reverse osmosis water filtration conductivity measurement and monitoring system.

FIG. 5 is a flowchart of a control system of a reverse osmosis water filtration conductivity measurement and monitoring system.

### DETAILED DESCRIPTION OF THE PRESENTLY PREFERRED REPRESENTATIVE EMBODIMENTS

Measurement systems are described herein suitable for the evaluation of fluid quality before and after passage through a fluid treatment system. The evaluation is based on relative measurements of conductivity. Suitable fluids for evaluation include, for example, water, such as water for commercial or residential use. The conductivity measurement can make use of a voltage measurement, comparator and a timer. The measurement systems are particularly suitable for use with a reverse osmosis water treatment system.

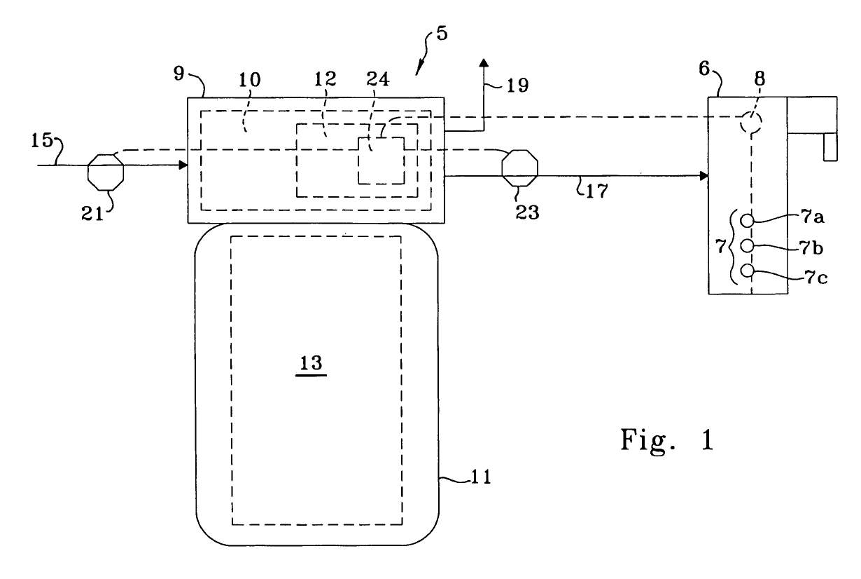

Reverse osmosis water treatment systems can be commercial or residential systems. One presently preferred representative embodiment of a reverse osmosis treatment system 5 is schematically illustrated in FIG. 1. Residential systems can be designed for filtering of the entire water flow through the residence of any portion thereof or for use with a particular appliance, such as a refrigerator. In some presently preferred embodiments, reverse osmosis treatment system 5 can comprise a water dispenser 6, such as, for example, a faucet. In one presently preferred representative embodiment, water dispenser 6 can have an output assembly comprising at least one status indicator 7 and a power supply 8. While the power supply 8, such as, for example, a replaceable battery, can be packaged within the water dispenser 6, in alternative embodiments, the power supply can be placed within the manifold or other location, or replaced with a connection to a power supply, such as a transformer connected to a house power supply.

Reverse osmosis treatment system 5 can further comprise a manifold 9, which in one presently preferred embodiments defines various input and output channels or flow paths. A cartridge filter 11 comprising a reverse osmosis filtration media 13 can be attached to the manifold 9 such that a supply flow 15 can be filtered into a filtered permeate flow 17 and a concentrated waste stream 19. As used herein for clarity and convenience, the term filtration media refers to a single-type of medium or a plurality of different types media used in combination for filtration. Various sensing elements such as, for example, flow sensors, conductivity sensors, pH sensors and the like, can be integrally positioned within the manifold 9 for sensing and measuring flow through supply flow 15, filtered permeate flow 17 and concentrated waste stream 19, or alternatively, the sensing elements can be placed apart from the manifold 9. In some presently preferred representative embodiments, the manifold 9 is placed remotely from the water dispenser 6. For example, the manifold 9 can be mounted under a sink, counter or remotely such as, for example, in a basement or similar location, while the water dispenser 6, including the at least one status indicator 7 and power supply 8 is mounted at a sink or on an appliance.

Reverse osmosis treatment system 5 can further comprise a system monitor circuit 10 mounted, for example, in the manifold 9. System monitor circuit 10 can comprise a PCB (Printed Circuit Board) assembly 12 having a microcontroller 24, various sensor interfaces; and an outlet assembly interface. Microcontroller 24 can comprise an algorithm to control operation of the reverse osmosis treatment system 5 and manage communications between the system monitor circuit 10 and the sensing elements, and between the system monitor circuit and the water dispenser 6. In one presently preferred representative embodiment, the algorithm comprises several interoperative portions according to a state of the reverse osmosis treatment system 5: a start state portion; a reset and initialization portion; a main state machine routine portion; an idle state portion; a flowing state portion; a timer expired state portion; a production test state portion; subroutine portions; and interrupt portions.

The reverse osmosis treatment system 5 can offer one or more of a number of advantages, for example, a simplified control unit design, increased efficiency of relative conductivity measurement and filtration effectiveness, and an improved power supply and control unit layout and interface. The reverse osmosis treatment system 5 of representative embodiments of the invention provides the at least one status indicator 7 indicating the system performance, either acceptable or unacceptable, based upon relative conductivity measurements, from which a filtration media effectiveness output can also be derived, as part of an energy efficient and simplified system design. The simplified design further provides accurate and fast readings.

A representative presently preferred embodiment of the water dispenser 6 comprises a control unit interface and power supply 8. The water dispenser 6 can further comprise at least one status indicator 7. In one representative embodiment, the status indicator 7 comprises light emitting diodes (LED) connected with common anodes and driven by the control unit. The status indicator 7 can comprise individual indicators such as, for example, a flow indicator 7a, a timer indicator 7b, and a filter monitor indicator 7c, with each having a different color or another distinguishing characteristic in representative embodiments. The flow indicator 7a indicates that the filtration system is correctly operating, in general when the faucet is turned on and water is flowing. The timer indicator 7b indicates when the power supply needs to be replaced, based upon an elapsed time or total flow. The filter monitor indicator 7c indicates when the filter membrane is not performing at a desired effectiveness, for example when a total dissolved solids (TDS) level reduction is below a predetermined threshold during use. Other types of visual displays can be used for status indicators, audio signals can be used additionally or alternatively to a visual display.

The water dispenser 6 can be electrically coupled to the system monitor circuit 10 by a wiring interface. In one presently preferred representative embodiment, a cable is coupled to a water dispenser 6 interface at the outlet assembly at a first end and to a printed circuit board (PCB) connector at a second end. Both the control unit interface and the PCB connector are described in further detail below.

In some representative embodiments, power supply 8 is a battery. The battery can be, for example, a 3-volt CR2032 lithium coin cell battery. In this particular embodiment, the power supply 8 can provide full system power for at least six months, after which the power supply 8 retains enough power to operate the timer indicator for some period of time as an alert that service is needed. In one representative embodiment, the period of time for providing an alert function is at least 37 days, although other time periods can also be available in various embodiments. The power supply 8 can be mounted in the water dispenser 6, providing an easier and more convenient change-out location when the battery needs service or replacement, although other placements can be used as convenient.

The manifold 9 can comprise a manifold housing defining various input and output channels/flow paths. Cartridge filter 11 and various sensing elements can be attached and positioned with respect to the manifold 9. The cartridge filter 11 can be sealed, such that the entire cartridge is replaced when the filter media is replaced. The filter cartridge can be connected to the manifold housing at a cartridge connection that operably interfaces with the filter cartridge.

The sensing elements generally comprise sensor probes to measure a relative conductivity of the input and product permeate water and can be placed in the input and output channels. In one presently preferred representative embodiment of the invention, the sensor probes comprise two pairs of electrodes respectively mounted in series in the housing, with a first sensor probe 21 positioned in the supply flow 15 and a second sensor probe 23 positioned in the filtered permeate flow 17. Sensor probes 21, 23 can generally be positioned so as to not require temperature compensation and can comprise gold-plated brass or another material known to those skilled in the art having compatible electrical properties. The sensor probes 21, 23 electrically and communicatively interface with the system monitor circuit 10, as will be described in further detail below. The sensing elements can also comprise a flow measuring element arranged in the channels.

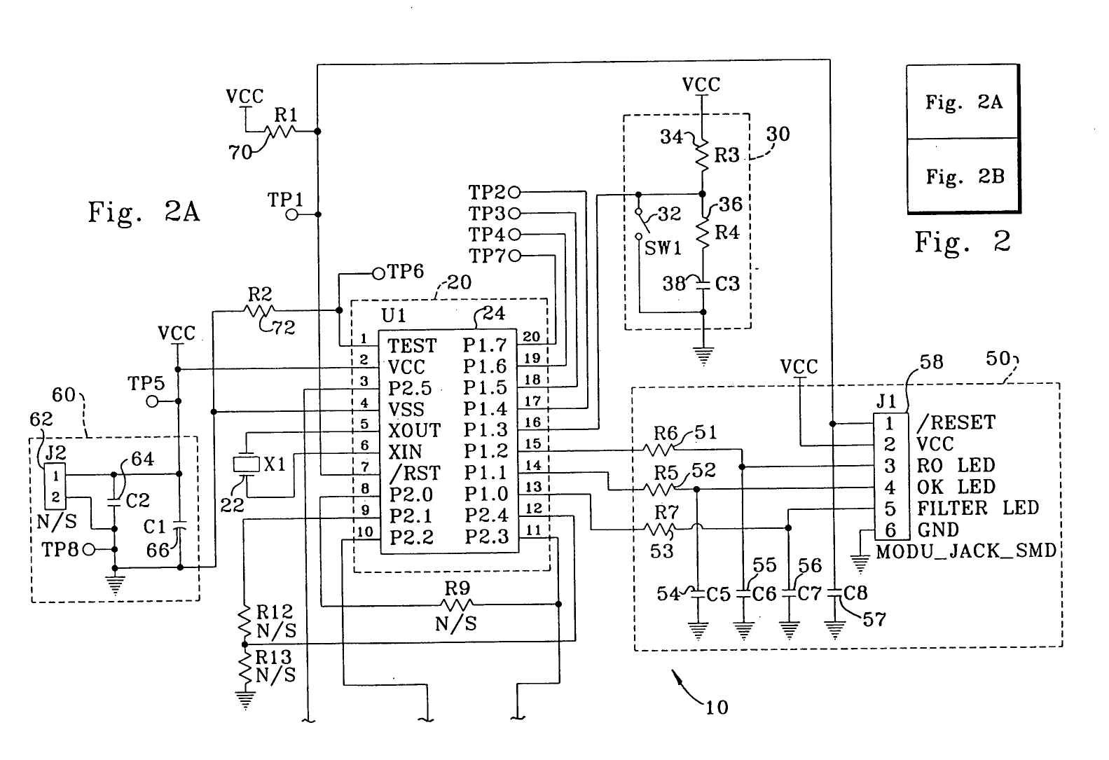

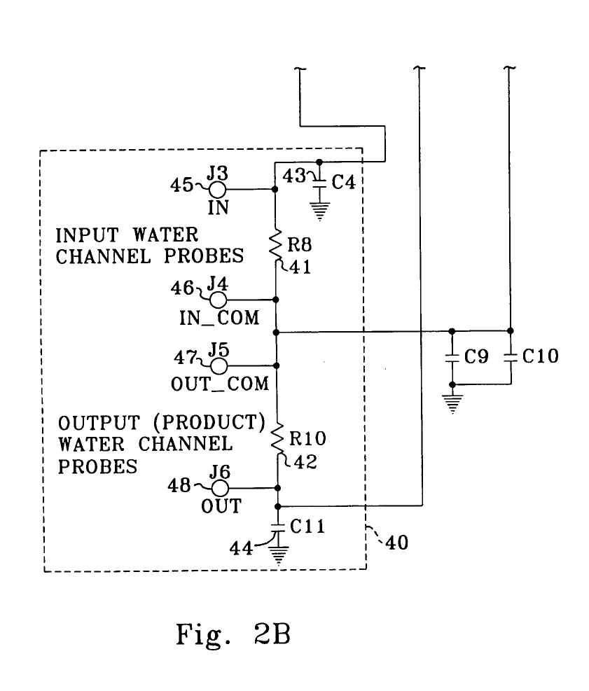

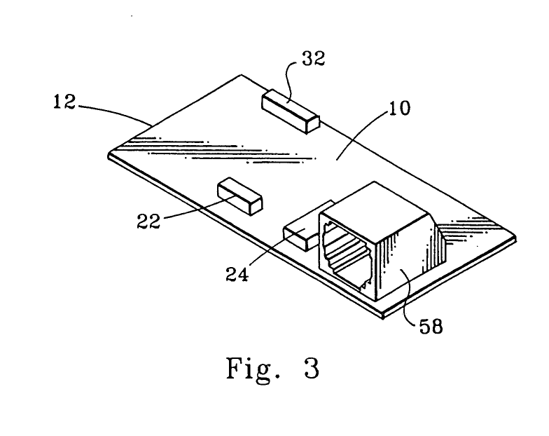

Referring to FIG. 2, a reverse osmosis water filtration conductivity measurement and monitoring system comprises a control unit having a system monitor circuit 10. Circuit 10 can be mounted on a PCB assembly 12 as shown in FIG. 2 and electrically interfaces with the outlet assembly and the sensing elements. PCB assembly 12 can be mounted in the manifold, although other positioning of the PCB assembly can be suitable.

Circuit 10 generally comprises a microcontroller with internal software, sensors, and related circuitry components and interfaces. In particular, one presently preferred embodiment of circuit 10 comprises an oscillator and control portion 20; a flow meter sense portion 30; a reverse osmosis sense portion 40; a status indicator drive portion 50; and a power input portion 60.

Oscillator and control portion 20 comprises a crystal 22 and microcontroller 24. In one presently preferred embodiment, crystal 22 is a 32.768 kilohertz (kHz), ±20 ppm surface-mount device (SMD) watch crystal, although other suitable crystals may be used in other alternative embodiments without departing from the spirit or scope of the disclosure.

Microcontroller 24 can comprise a Texas Instruments MSP430F1111A microcontroller in one presently preferred representative embodiment, which comprises an internal comparator module and internal circuitry and components to directly interface to crystal 22. Other suitable microcontrollers, such as, for example, those in the TI MSP430 family that have an internal comparator module, can also be used. The comparator module of the TI MSP430F1111A microcontroller provides a comparison result, for example a comparison of two external inputs to the microcontroller, a comparison of each external input with 0.25×Vcc or 0.5×Vcc, or a comparison of each external input with an internal-reference voltage, allowing voltage, current, resistive, and capacitive measurements. Accordingly, a function of the internal comparator module can be to indicate which of two external or internal references voltages is higher and drive an output pin high or low accordingly. The Texas Instruments Application Report SLAA071, entitled “Economic Measurement Techniques with the Comparator A Module,” of October 1999 describes the TI MSP430 family comparator module in more detail and is incorporated herein by reference to the extent not inconsistent with the present disclosure. Microcontroller 24 also comprises an internal high-speed oscillator.

One presently preferred embodiment of flow meter sense portion 30 comprises a switch 32, resistive element 34 and 36, and a capacitive element 38. In one representative embodiment, switch 32 is a reed switch, in particular a Meder MK22-B-4. Switch 32 is normally open and electrically communicates with microcontroller 24 via resistive element 34. Switch 32 is operably closed by a rotating magnetized fin of an impeller of the reverse osmosis water filtration system. Rotation of the impeller, and subsequent closure of switch 32, indicates that water is flowing through the system. In one presently preferred representative embodiment, a pulse rate of about 3328 pulses per minute correlates to a filtration system flow rate of about 1.0 gallon per minute while a pulse rate of about 4160 pulses per minute correlates to a flow rate of about 1.25 gallons per minute. The resulting period is about 14.42 milliseconds (mS). Switch 32 has a maximum operate time of about 0.5 mS and a maximum release time of about 0.1 ms in this representative embodiment, both times compatible with the pulse rate described above.

Reverse osmosis sense circuit 40 comprises resistive elements 41 and 42, capacitive elements 43 and 44, input water channel sensor probe interfaces 45 and 46, and product water channel sensor probe interfaces 47 and 48 in one presently preferred embodiment. Resistive elements 41 and 42 are arranged to ensure that a suitable low current can flow across probes 45-48. In one presently preferred representative embodiment, resistive elements 41 and 42 each comprise a one mega Ohm (MΩ) resistor, although other resistor values can be used such that the resistive elements allow some current to flow across probes 45-48 to measure the proportional conductivity between the input and product water channels. Capacitive elements 43 and 44 are arranged to decouple noise and switching transients and in one presently preferred embodiment each comprises a 0.1 micro Farad (μF) capacitor. Input probe interfaces 45 and 46 and product probe interfaces 47 and 48 are arranged in series and are operably and respectively connected to the electrode pairs in a manifold flow channel of the filtration system as previously described, and to microcontroller 24 at a comparator input.

In one presently preferred representative embodiment of circuit 10, status indicator drive portion 50 comprises resistive elements 51, 52, and 53; capacitive elements 54, 55, 56, and 57; and connector 58. Connector 58 electrically couples filtration system status indicators mounted in the outlet assembly to remote of circuit 10. Connector 58 can be, for example, a female RJ-11 telephone jack-type connector having six pins and adapted to interface with a first end of a telephone cable assembly, a second end of which is operably coupled to the outlet assembly. In the illustrated embodiment, the pin-outs of connector 58 are as follows: Pin 1 is a reset; Pin 2 connects to battery positive and LED anode common (+Vcc); Pin 3 connects to the filter monitor indicator; Pin 4 connects to the flow indicator; Pin 5 connects to the timer indicator; and Pin 6 is ground. As will be appreciated by those skilled in the art, other pin-outs can be used, as the above-identified pin-outs are exemplary of only one representative embodiment. Pins 3, 4, and 5, and thus status indicator 7 are coupled to microcontroller 24 by resistive elements 51, 52, and 53, respectively. Resistive elements 51, 52, and 53 can vary in one embodiment according to the particular status indicators used. For example, resistive elements 51, 52, and 53 can be sized according to the current required to drive the particular LED status indicators electrically connected to connector 58. In one presently preferred embodiment, resistive elements 51, 52, and 53 comprise a 220Ω, a 150Ω, and a 220Ω resistor, respectively, although other values and configurations of resistive elements 51, 52, and 53 can be used in other representative embodiments. Capacitive elements 54, 55, 56, and 57 are arranged to decouple noise and each comprises a 0.01 μF capacitor in this presently preferred exemplary embodiment.

Power input portion 60 can comprise a connector 62, or alternatively connector 58 and capacitive elements 64 and 66. Either of connector 62 or connector 58 can interfaces to the power supply 8, which as previously described can be a 3-volt CR2032 lithium coin cell battery in one representative exemplary embodiment of the invention. In the case of connector 58 interfacing with the power supply 8, the telephone cable assembly supplies energy from the 3-volt battery to the power input portion 60. Capacitive element 64 is a high frequency decoupling capacitor. Capacitive element 66 is a local bulk capacitor to provide voltage stability between a standby or sleep mode of circuit 10 and a wake-up power supply demand. In one presently preferred representative embodiment, capacitor element 66 comprises a 10 μF capacitor, although other capacitor sizes can also be used.

As illustrated, circuit 10 comprises resistive elements 70 and 72. Resistive elements 70 and 72 can be pull-up and pull-down resistors connected to microcontroller 24. Resistive elements 70 and 72 comprise 100 kiloΩ (kΩ) and 20 kμ resistors, respectively, in one presently preferred representative embodiment.

Microcontroller 24 is operable to control and monitor operation of the filtration system of the invention and can generally include a control algorithm. The control algorithm is an operating platform for microcontroller 24 and manages communications between microcontroller 24, the sensing elements and the outlet assembly, respectively. The control algorithm can be written to microcontroller flash/ROM (read-only memory), although this can vary according to the particular microcontroller used. A presently preferred representative embodiment of the control algorithm relating to microcontroller 24, the aforementioned control system, and the disclosure of the presently preferred representative embodiments, is submitted herewith in the following section titled program listing and is hereby incorporated by reference.

The control algorithm can comprise several interoperative portions that manage system and component communications, operations, and outputs according to a various operational states of the filtration system. In particular, the control algorithm can control operation and function of microcontroller 24 from an initial power-on start state, through various operative states and idle states, to a power-off state.

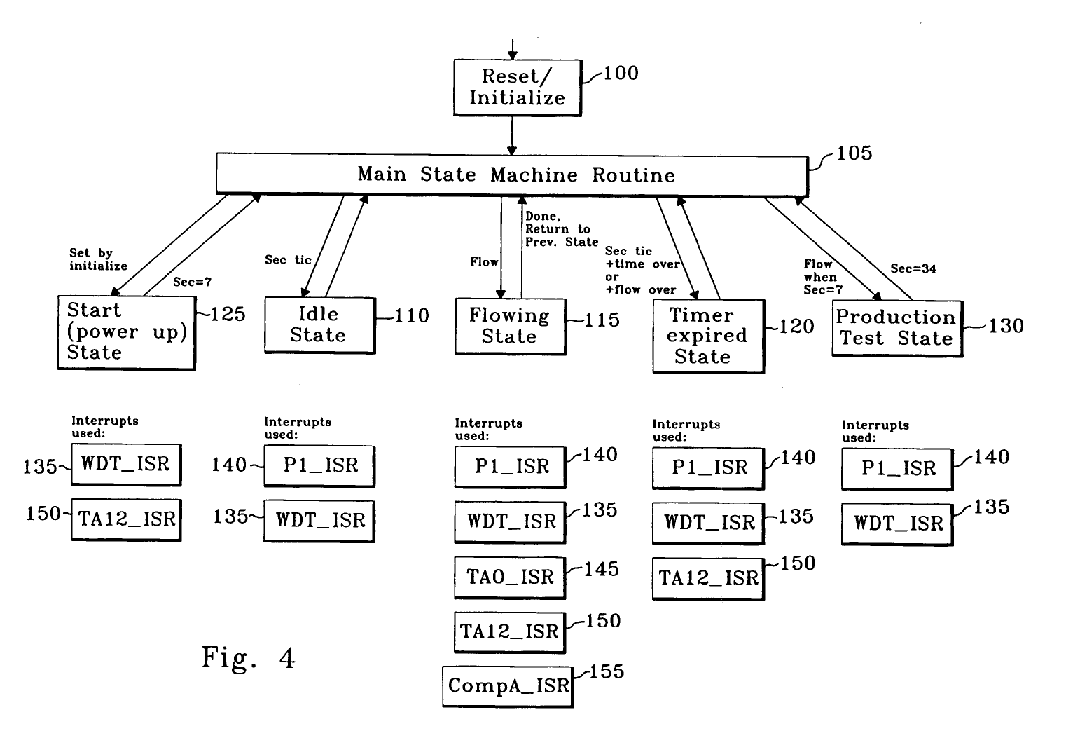

Referring to FIG. 4, a control algorithm according to a presently preferred representative embodiment, resident in microcontroller 24, can comprise a start state portion 125; a reset and initialization portion 100; a main state machine routine portion 105; an idle state portion 110; a flowing state portion 115; a timer expired state portion 120; a production test state portion 130; interrupt portions 135, 140, 145, 150, and 155; and subroutine portions.

At reset and initialization portion 100, microcontroller 24 conducts initialization of system inputs and outputs to conform to the hardware, set up the timing of oscillator 22 and high speed oscillator internal to microcontroller 24, and initialize registers and memory variables to begin execution of state machine main loop routine portion 105.

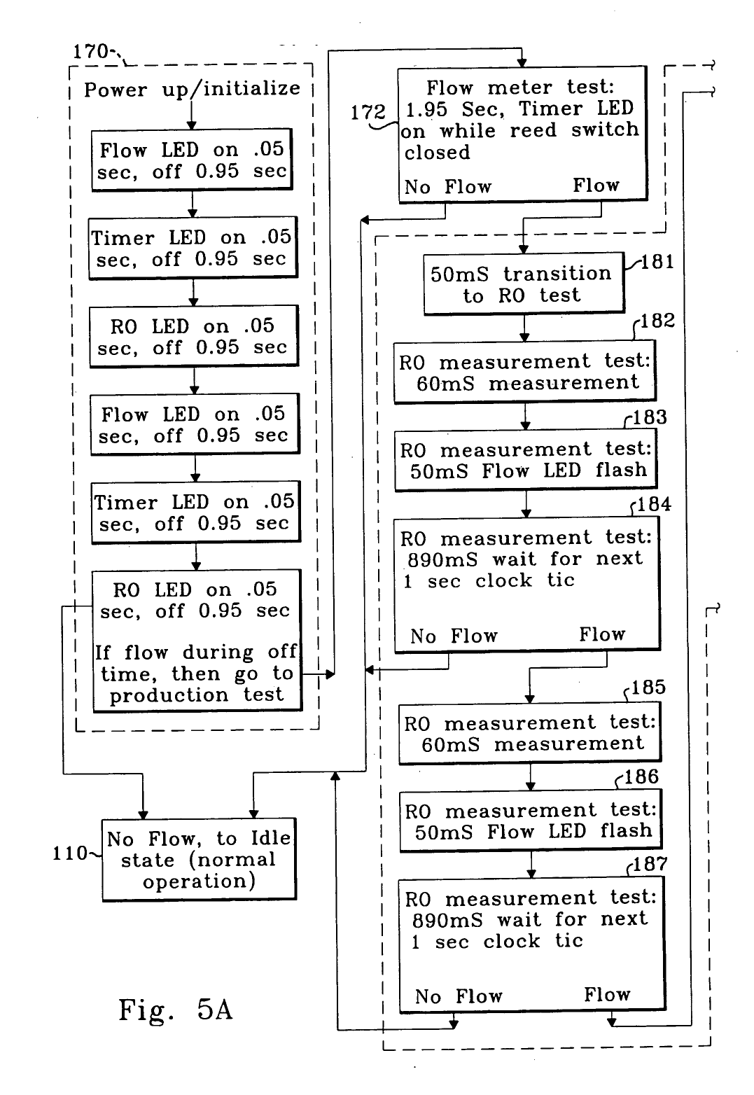

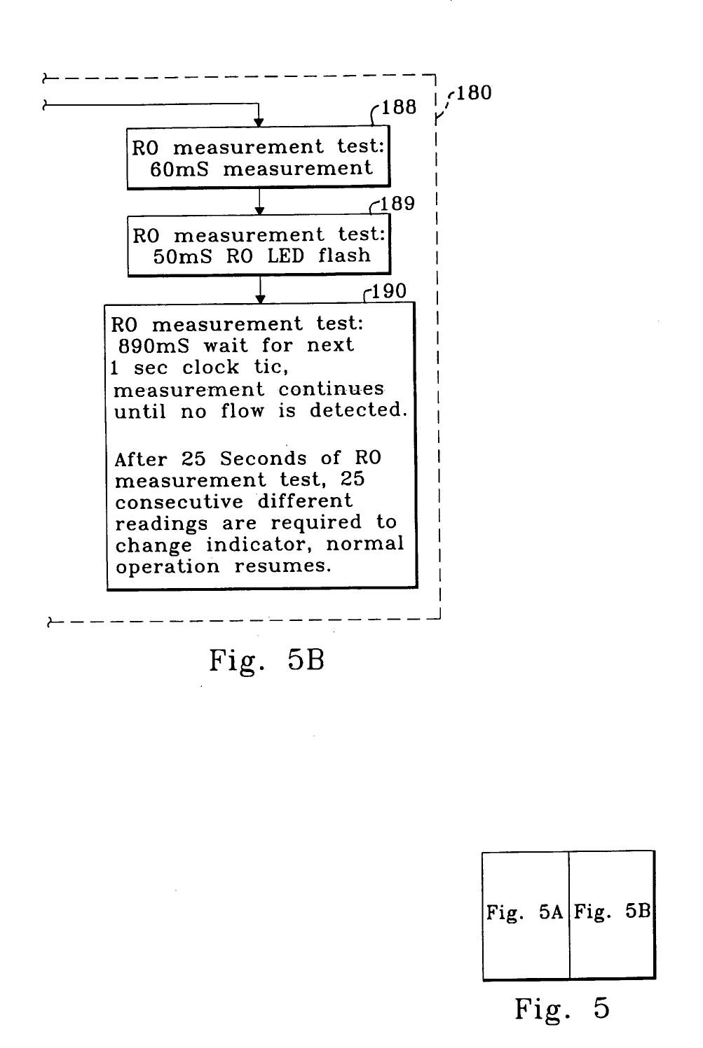

In a start state portion 125, microcontroller 24 blinks the status indicator 7 in a startup pattern 170 as shown in the flowchart of FIG. 5. For example, the LEDs can be illuminated for 0.05 seconds, followed by 0.95 seconds off, repeated twice and in the following order: flow indicator, timer indicator, filter monitor indicator. This startup pattern and timing can be varied in other suitable embodiments of the control algorithm. If water flow is detected by switch 32 (refer to FIG. 2) during the latter second of the pattern described above, microcontroller 24 goes into production test state 130. If no flow is detected during the latter second of the startup pattern, controller 24 goes into idle state 110.

In one presently preferred representative embodiment, all state routines return to main loop routine 105. A main purpose of main loop routine 105 in the embodiment of FIG. 4 is to put microcontroller 24 into an very low current sleep mode to conserve power until microcontroller 24 is awoken by a real time clock one second tic interrupt, at which time microcontroller 24 executes the appropriate state routine.

Microcontroller 24 is idle in idle state 110 and in a timer expired state 120. Timer expired state 120 is in lieu of idle state 110 after a timer threshold has been exceeded. To conserve power, microcontroller 24 goes into idle state 110 whenever possible. For example, microcontroller 24 can go into an idle state if no fluid flow is detected in the startup pattern described above with reference to start state portion 125, and if no fluid flow is detected following a flow meter test described below with reference to production test state 130. Microcontroller 24 can also go into idle state 110 at other times when it is desirable to conserve power and when active operation of microcontroller 24 is not necessary.

Flowing state 115 can include eight main portions in one presently preferred representative embodiment. Microcontroller 24 goes into flowing state 115 when water flow is detected by a closing of switch 32 from rotation of the impeller, or alternative flow meter. In a first portion of flowing state 115, microcontroller 24 sets up ports, timers, a comparator, and variables for a new reverse osmosis measurement.

Next, microcontroller 24 makes a new reverse osmosis measurement. According to presently preferred representative embodiments of the disclosure, microcontroller 24 uses an internal comparator module to make a ratiometric determination of the effectiveness of the filtration media. In other words, microcontroller 24, in cooperation with the input and product water sensor probes 21, 23 that are arranged in the flow on opposing sides of the filtration media and communicate with microcontroller 24 at probe interfaces 45, 46, 47, and 48, determines a TDS reduction percentage based upon a relative conductivity of the input water and the product water to determine an effectiveness of the filtration media. If the input water is impure and has some amount of dissolved solids, and a voltage is introduced across the input and product water probes, ion (current) flow will be introduced between the sensor probes 21, 23, wherein the current flow will be proportional to the level of TDS in the water.

To measure the conductivity of the water, and thereby determine a TDS reduction percentage and filtration media effectiveness according to presently preferred representative embodiments of the system, microcontroller 24 starts a port toggling loop that switches the port outputs of microcontroller 24 that are connected to the sensor probes 21, 23. In the embodiment of circuit 10 depicted in FIG. 2, these ports are Pins 3 (input water) and 10 (product water). When measuring, microcontroller 24 toggles Pins 3 (45) and 10 (48) alternately, one side connected to battery positive, the other to battery negative, then reverses the applied polarity to set up an ion flow in the opposite direction. The series connected sensor probes 21, 23 are thus excited by an alternating current driven by the ports of microcontroller 24. Introducing the flow in the first direction also plates the electrodes, then switching the direction of the flow plates out the probes, helping to keep the sensor probes 21, 23 clean. Microcontroller 24 can quickly toggle the ports, providing both fast reads and an ability to fine-tune the measurement sensitivity. Port timing and servicing is interrupt-driven.

The current flow through the series connection of the input water sensor probes 21 and the product water sensor probes 23 produces voltages across the electrode pairs that are related to a difference in conductivity of the input water and the product water in the two channels. This voltage divider is sensed by microcontroller 24 via the common junction of the electrode pairs at interfaces 46 and 47 at Pin 11, a comparator module input. As previously described for one presently preferred representative embodiment, microcontroller 24 comprises an internal comparator module. A second (internal) input to the comparator module in this embodiment is an internal 0.25*Vcc reference voltage, thus both the reference voltage and the measurement stimulus are derived from Vcc. The comparator module of microcontroller 24 therefore determines an effectiveness of the filtration media by measuring a voltage across the input and product sensor probes 21, 23 that is related to a difference in conductivity between fluid in the input channel and fluid in the product channel. The relation between the voltage and the relative conductivity may be proportional. This direct measurement of the relative conductivity of representative embodiments of the subject invention allows many non-linear factors to cancel out, reduces the number of analog circuit components in circuit 10 necessary to make a determination of filtration effectiveness, and does not require absolute measurements of inlet or product water conductivity and subsequent calculations of relative conductivity.

Accordingly, for the loops in which the product water probe (interface 48) is switched to battery positive, a measurement is performed. Microcontroller 24 comparator (Pin 11) connected to the common water probe interfaces 46 and 47 is activated and, when the internal comparator changes state, the current port toggle timer value is captured by the comparator interrupt routine. The reference for the measurement comparator is the internal 0.25*Vcc voltage, where Vcc is equal to battery positive. For a reverse osmosis filter membrane with a relatively good TDS rejection ratio, a voltage at Pin 11 is, and stays, lower than the comparator threshold for a duration of the measurement pulse.

As the TDS rejection ratio declines, the comparator input voltage rises, approaching battery voltage/2. At a region of interest where the TDS rejection is marginal, the comparator input voltage is below the reference voltage at the beginning of the measurement pulse. As current flows through the water channels, the electrochemical properties permit more current flow, and thus lower resistance, in the product water channel. This in turn ramps up the voltage seen by the internal comparator of microcontroller 24 and triggers the internal comparator when the voltage reaches the reference voltage. In other words, the time required for the internal comparator to switch can be seen as a high-resolution indication of the TDS rejection ratio. Accordingly, a grossly low TDS rejection ratio results in an internal comparator input voltage, at Pin 11, that is always above the reference voltage, and a high TDS rejection ratio results in an internal comparator input voltage that is always below the reference voltage. Microcontroller 24 can therefore have a three-stage reading: a good reading, a bad reading, and a high-resolution intermediate reading of the rejection ratio. The high-resolution intermediate range corresponds to a range of rejection ratios wherein the rejection ratio is transitioning between acceptable and unacceptable rejection ratios. In one presently preferred representative embodiment, the high-resolution intermediate range is set at about at 75% rejection ratio wherein a rejection ratio greater than 75% would represent an acceptable rejection ratio while a rejection ratio less than 75% would represent an unacceptable rejection ratio. Alternatively, the high-resolution intermediate range can be set at various alternative rejection ratios based on filtration system variables such as, for example, membrane type, feed water quality, feed water type and acceptable criteria for permeate water quality.

Microcontroller 24 performs limit testing at the beginning of this measurement portion of flowing state 115 to verify as correct an initial internal comparator status. Additionally, microcontroller 24 also captures the result if the internal comparator does not transition during the measurement portion. As measurements are performed, microcontroller 24 discards the first two measurements to allow for settling, and the next four measurements are averaged, in representative embodiments. Next, the averaged reading is compared to a test threshold to determine whether the reading passes or fails.

After evaluating the averaged reading, microcontroller 24 reviews the accumulated results to determine whether a state of the filter monitor indicator should be changed. In one presently preferred representative embodiment, twenty-five consecutive below-threshold results are required to change a state of the indicator. These accumulated results are temporarily stored in a FIFO (first in, first out) buffer in microcontroller 24 RAM (random access memory).

In a final portion of one embodiment of flowing state 115, corresponding status indicator(s) are turned on and a timer internal to microcontroller 24 is initiated for a blink-on time. A timer interrupt routine turns the timer off. The internal comparator and reference is powered off to reduce power consumption. Microcontroller 24 then returns to the previous state.

In timer expired state 120, microcontroller 24 blinks the timer indicator 7b after either the six-month time or totalized flow threshold is exceeded. Microcontroller 24 can periodically wake up in order to update an internal elapsed time counter and in one presently preferred embodiment can record elapsed time for an extended period, e.g., some period of days, weeks, or months, during which power consumption is reduced by being in either of, idle state 110 or timer expired state 120. After this extended period has expired, microcontroller 24 activates the timer indicator 7b. In one presently preferred representative embodiment, the totalized flow threshold can be set at about 900 gallons, and the timer indicator 7b is activated once this threshold is exceeded. The timer interrupt routine turns the timer indicator 7b off. If water flow is detected while microcontroller 24 is in this state, microcontroller 24 goes into flowing state 115, a measurement as previously described is performed, and microcontroller 24 subsequently returns to timer expired state 120.

In one presently preferred embodiment, resetting the timer indicator 7b can be accomplished by removing power supply 8 from the system monitor circuit 10 and replaced. In other presently contemplated embodiments, system monitor circuit 10 can comprise a reset switch or button to break the circuit and reset the timer indicator 7b. Such a switch or reset signal can be sent automatically upon replacement of the filter in appropriate embodiments.

In production test state 130, a first phase is flow meter test 172, as shown in FIG. 5. If water flow is detected during the first 1.95 seconds in state 130, the timer indicator 7b flashs for each pulse detected by the impeller. In one embodiment, the timer indicator 7b is illuminated for the duration of the switch closure. This permits testing of the integrity of reed switch 32 and its actuating impeller magnet.

Following flow meter test phase 172, microcontroller 24 performs a reverse osmosis measurement phase 174 in which a measurement is taken once each second if flow is still detected. Phase 174 uses the same routine as described above with regard to flowing state 115. Thus, after the initial 1.95 second flow meter test, the following sequence and approximate timing can occur in presently preferred representative embodiments of the procedure:
50 mS transition to reverses osmosis measurement state (181)
60 mS reverses osmosis measurement (182)
50 mS flow indicator flash (183)
Delay (approximately 890 mS) for next one second clock tic (184)
60 mS reverse osmosis measurement (185)
50 mS flow indicator flash (186)
Delay (approximately 890 mS) for next one second clock tic (187)
60 mS reverse osmosis measurement (188)
50 mS filter monitor indicator flash if acceptable input and product water has not been in the flow channels for the duration of the reverse osmosis test phase (189)

The flow indicator 7a or filter monitor indicator 7c flash as defined for normal operation, with an exception that only two consecutive different measurement results will change a state of the indicator(s). If flow was not detected in the reverse osmosis measurement test phase, microcontroller will revert to normal operation and go into idle state 110. After about 25 seconds in the reverse osmosis measurement test phase, microcontroller 24 reverts to normal operation (190), which in one presently preferred representative embodiment requires twenty-five consecutive different state readings, i.e., fail readings if the filtration media had been satisfactory or satisfactory readings if the filtration media had indicated failure, to toggle the state of the status indicators.

It will be appreciated by those skilled in the art that the particular times described above and herein throughout, and as depicted in the drawings, are exemplary and can vary, their use herein being for the purposes of illustration and description of representative embodiments of the invention.

In control algorithm portions 105, 110, 120, 125, and 130 as described above, five interrupts exist in one embodiment: a watchdog/real time interrupt 135; a switch interrupt 140; a measurement port toggle interrupt 145; an indicator blink interrupt 150; and a reverse osmosis measurement interrupt 155.

Watchdog/real time interrupt 135 occurs once per second in one presently preferred representative embodiment, when microcontroller 24 is in an ultra low current sleep mode. Oscillator 22 is used as the time base, and after one second has elapsed, microcontroller 24 starts up in active mode and executes interrupt 135. Elapsed seconds and hours are counted and are compared to a production test timeout and timer limit. In one presently preferred representative embodiment, the timer limit is predefined and is, for example, six months. If this six-month threshold is exceeded, timer expired state 120 is next called. Upon return from interrupt 135, microcontroller 24 stays in an active mode and executes state main machine main loop 105. Interrupt 135 is always enabled in one representative embodiment of the invention.

Switch interrupt 140 can occur when closure of switch 32 is detected. A totalized flow counter is incremented and the gallon count is compared to the predetermined totalized flow threshold. If the threshold is exceeded, timer expired state 120 is called. Microcontroller 24 returns to the previous sleep state upon return from interrupt 140. On the next one-second tic, flowing state 115 is executed. Interrupt 140 is enabled after start state 125 and is disabled for the flow meter test phase if production test state 130 is entered.

In one presently preferred representative embodiment, measurement port toggle interrupt 145 occurs when the reverse osmosis measurement port toggle of flowing state 115 times out. Interrupt 145 switches the port drive and increments the toggle counter unless the count threshold has been reached. Interrupt 145 returns to flowing state 115 with microcontroller 24 in active mode to proceed with the next step of the measurement routine described above. Interrupt 145 is only enabled in flowing state 115 when the measurement ports have been turned on in one embodiment.

Indicator blink interrupt 150 can turn off the status indicator 7s after a blink time has elapsed. In one presently preferred representative embodiment, the blink time is predefined as about 50 mS, although other blink times can also be defined. Microcontroller 24 returns to a previous sleep state upon return from interrupt 150, and interrupt 150 is only enabled when the status indicators have been turned on in one embodiment.

Reverse osmosis measurement interrupt 155 is used to capture the measurement port toggle timer count when the reverse osmosis measurement comparator trips. Microcontroller 24 returns to flossing state 115 in active mode to proceed with the next step in the measurement routing previously described. In one presently preferred representative embodiment, interrupt 155 is only enabled in flowing state 115 when comparator output is valid.

The reverse osmosis filtration system of representative embodiments of the invention thereby provides output indicative of relative conductivity. A filtration media effectiveness output can also be derived from the relative conductivity. The reverse osmosis filtration system provides an improved energy efficiency and simplified system design while also providing more accurate and faster readings.

Although various representative embodiments of the present invention have been disclosed here for purposes of illustration, it should be understood that a variety of changes, modifications and substitutions may be incorporated without departing from either the spirit or scope of the present invention.

What is claimed is:

1. A fluid treatment system comprising:
a manifold comprising an inlet channel, and a product channel;
a fluid treatment media operably connected between the inlet channel and the product channel;
a first sensor element positioned in the inlet channel;
a second sensor element positioned in the product channel;
at least one status indicator; and
a control unit electrically coupled to the at least one status indicator, the control unit comprising a microcontroller, the microcontroller comprising a voltage comparator having a first input port, a second input port, and an output port,
wherein the first input port is in electrical communication with the first sensor element and the second sensor element, and the second input port is in electrical communication with a reference voltage, and wherein a signal at the output port is related to a relative conductivity of the fluids respectively evaluated using the first and second sensor elements.

2. The fluid treatment system of claim 1 wherein electrical connection of the first input port with the first sensor element and the second sensor element result in the voltage comparator evaluating the relative conductivity of the fluids with respect to the reference voltage for determining a good rejection ratio, a bad rejection ratio and an intermediate rejection ratio range.

3. The fluid treatment system of claim 2 wherein the control unit further comprises a timer controlled by the output port of the comparator so as to provide a high resolution measurement when the relative conductivity is within the intermediate rejection ratio range.

4. The fluid treatment system of claim 3 wherein the intermediate rejection ratio range corresponds to a selected pass/fail rejection threshold for the fluid treatment media.

5. The fluid treatment system of claim 4 wherein fluid treatment media comprises a reverse osmosis filtration media and the pass/fail rejection threshold corresponds to about a 75% rejection ratio for the filtration media.

6. The fluid treatment system of claim 1 wherein the fluid treatment media comprises a filtration media.

7. The fluid treatment system of claim 1 wherein the fluid treatment media comprises a reverse osmosis filtration media.

8. The fluid treatment system of claim 1 further comprising a power source.

9. The fluid treatment system of claim 1 further comprising an outlet assembly comprising a faucet operatively connected to the product channel.

10. The fluid treatment system of claim 1 comprising a power source and the at least one status indicator comprising three status indicators wherein the power source and the three status indicators are packaged with the outlet assembly.

11. The fluid treatment system of claim 10 wherein one status indicator is configured to indicate the flow status, another status indicator is configured to indicate the power source status, and a further status indicator is configured to indicate the fluid quality.

12. A method of monitoring a fluid treatment system, the method comprising the steps of:
exciting a first sensor element arranged in an inlet fluid flow with a current;
exciting a second sensor element arranged in a product fluid flow with a current;
measuring a voltage across the first sensor element and the second sensor element; and
outputting a system status indicator based upon the voltage.

13. The method of claim 12 wherein fluid flow passes through a reverse osmosis filtration element between the inlet fluid flow and the outlet fluid flow.

14. The method of claim 12 wherein the current used to excite the first sensor and the current used to excite the second sensor are alternating currents.

15. The method of claim 12 wherein fluid flow is detected prior to exciting the sensor elements.

16. The method of claim 12 wherein a relative conductivity of the inlet lfuid flow and the product fluid flow is determined from the voltage.

17. The method of claim 16 wherein a total dissolved solids reduction percentage is determined from the relative conductivity.

18. The method of claim 12 wherein the voltage is evaluated relative to a reference voltage using a microcontroller.

19. The method of claim 18 wherein the microcontroller is programmed using non-volatile memory.

20. The method of claim 12 wherein an indicator identifies if desired fluid quality values are not being obtained in the product flow.

21. A control unit for a reverse osmosis filtration system, the control unit comprising:
a microcontroller comprising a voltage comparator and at least one output port, the voltage comparator having a first comparator input port, a second comparator input port, and a comparator output, the first comparator input port being connected to a reference voltage;
a first sensor element interface and a second sensor element interface electrically connected in series to generate a current flow through the two sensors with one sensor being located in an input flow channel and a second sensor being located in a product flow channel, an electrical connection connecting between the first sensor element interface and the second sensor element interfaces with the second comparator input port;
a remote power source interface electrically connected to the microcontroller; and
an output interface electrically connected to the at least one output port of the microcontroller,
wherein an electrical signal at the at least one output port is related to a signal at the comparator output.
